(19) United States
(12) Patent Application Publication
(10) Pub. No.: US 2018/0355164 A1
(43) Pub. Date: Dec. 13, 2018

(54) PHOTOPOLYMERISABLE COMPOSITION COMPRISING A (METH)ACRYLIC MATRIX AND (METH)ACRYLIC BLOCK COPOLYMERS

(71) Applicant: Arkema France, Colombes (FR)

(72) Inventors: Raber INOUBLI, Pau (FR); Charles BOURROUSSE, Paris (FR)

(73) Assignee: Arkema France, Colombes (FR)

(21) Appl. No.: 15/756,901

(22) PCT Filed: Aug. 26, 2016
(86) PCT No.: PCT/FR2016/052125

§ 371 Date: Jul. 23, 2018

(30) Foreign Application Priority Data
Sep. 4, 2015 (FR) 15 58207

(51) Int. Cl. C08L 33/12; C08L 33/08; C08F 20/18; C08F 2/48

(52) U.S. Cl. CPC C08L 33/12; C08L 33/08; C08L 75/14; C08F 2/48; C08F 2800/20; C08F 20/18

(57) ABSTRACT

The invention relates to a photopolymerizable composition based on a (meth)acrylic matrix, mainly characterized in that it further comprises a (meth)acrylic block copolymer, or a blend of (meth)acrylic black copolymers, dissolved in said (meth)acrylic matrix and one or more photoinitiators.

### TECHNICAL FIELD

The invention relates to the field of compositions that can be cured by electromagnetic radiation of gamma, IR, visible or UV type.

More particularly, the invention relates to a composition comprising a (meth)acrylic matrix suitable for being polymerized under light radiation, and more particularly under ultraviolet (UV) radiation.

### PRIOR ART

In general, block copolymers become nanostructured, by phase segregation between the blocks, thus forming nanodomains, on scales of less than 50 nm, This nanostructuration induced by the block copolymers makes it possible, when they are introduced into a thermosetting matrix, of epoxy type for example, to provide improved mechanical properties such as impact strength or resistance to crack propagation. Such an incorporation of Methacrylic block copolymer into an epoxy thermosetting resin is described in documents WO 2006/077153 or U.S. Pat. No. 7,767,757 for example. The applications envisaged by incorporating such methacrylic block copolymers into epoxy thermosetting matrices especially lie in the production of composite materials or else adhesives.

This ability of the (meth)acrylic block copolymers to become organized on the nanometric scale in thermosetting matrices was then transposed to another thermosetting matrix based on (meth)acrylic monomers in order to develop structural methacrylic adhesives, that is to say “two-part” adhesives. Such products comprise a first component of resin type generally comprising a matrix of monomers associated with one or more polymers, and also a second component of initiator type. The initiator is intended to be brought into contact with the resin in order to initiate the polymerization of the monomers that it contains, enabling the adhesive to cure. The assembly forms a crosslinked polymer network and the adhesive consequently fulfils its bonding role. This incorporation of block copolymers into a thermosetting (meth)acrylic matrix for the production of structural adhesives is described in document WO12131185. The introduction of the (meth)acrylic block copolymer enables a compromise to be obtained between the tensile-shear modulus and the elongation at break.

Other thermosetting polymer systems based on specialty monomers exist that are used for polymerizations by crosslinking under ultraviolet UV radiation. This type of thermosetting polymer system comprises a chemically crosslinked three-dimensional network which, just like epoxy resins, is brittle and not very resistant to crack propagation. To overcome this problem, use is generally made of curing agents, which may optionally be block copolymers for mixed epoxy/methacrylic systems by UV-cationic polymerization, as described in document WO 2007/048819. Document WO 2008/110564 also describes the use of a block copolymer, one of the blocks of which comprises methyl methacrylate, such as a block copolymer of styrene-butadiene-methacrylate SBM type for example, in an epoxy type thermosetting matrix. Document WO 2007/124911 describes the use of a block copolymer of the following types: SBM (styrene-butadiene-methacrylate) or SBS (styrene-butadiene-styrene), or SIS (styrene-isoprene-styrene) and their hydrogenated versions, or SEBS in an epoxy-type thermosetting matrix.

(Meth)acrylic compositions based on entirely (meth)acrylic matrices also exist, comprising (meth)acrylic monomers and/or oligomers. These compositions further comprise one or more photoinitiators that make it possible to initiate the radical polymerization reaction under UV radiation, After exposure to light, the crosslinked (meth)acrylic composition obtained is brittle and has a low impact strength and a poor resistance to crack propagation. This type of entirely (meth)acrylic composition may be used in many applications, among which mention may be made of 3-D printing, coatings or adhesives for example. However, for applications of this type, it is advisable to obtain a composition, after UV crosslinking, that is resistant to tearing, resistant to crack propagation and withstands impacts.

### TECHNICAL PROBLEM

The aim of the invention is thus to overcome at least one of the disadvantages of the prior art. In particular, the objective of the invention is to propose a photopolymerizable (meth)acrylic composition that makes it possible to obtain, after polymerization under UV radiation, improved impact strength, tear strength and resistance to crack propagation.

### BRIEF DESCRIPTION OF THE INVENTION

Surprisingly, it has been discovered that a photopolymerizable (meth)acrylic composition based on a (meth)acrylic matrix, mainly characterized in that it further comprises a (meth)acrylic block copolymer, or a blend of (meth)acrylic block copolymers, dissolved in said matrix and one or more photoinitiators, has increased mechanical properties after crosslinking under UV radiation, and in particular improved impact strength, resistance to crack propagation and tear strength.

According to other optional features of the adhesive composition, to be considered separately or in combination:
the (meth)acrylic matrix comprises one or more acrylic or methacrylic monomers and one or more acrylic or methacrylic oligomers;
advantageously, the (meth)acrylic block copolymer(s) is (are) chosen from block copolymers having one of the following structures: B-M, M-B-M, wherein:
   each block is connected to the other by means of a covalent bond or an intermediate molecule connected to one of the blocks by a covalent bond and to the other block by another covalent bond,
   M is a polymer block of polymethyl methacrylate (PMMA), namely a homopolymer or a copolymer comprising at least 50% by weight of methyl methacrylate,
   B is an elastomeric polymer block incompatible with the (meth)acrylic matrix and with the M block, and the glass transition temperature (Tg) of which is below ambient temperature, advantageously below 0° C. and preferably below −20° C.;
the (meth)acrylic copolymer(s) comprise(s) only (meth)acrylic blocks, that is to say that all its blocks are polymers or copolymers predominantly comprising (meth)acrylic monomers;
the (meth)acrylic block copolymer(s), and also the constituent monomers and/or oligomers of the (meth)acrylic matrix may be functionalized;
the (meth)acrylic matrix is a thermosetting matrix, and the (meth)acrylic composition is photocrosslinkable;
the composition advantageously comprises (limits included):
from 0.1% to 40%, preferably between 1% and 20%, advantageously between 5% and 15% by weight of (meth)acrylic block copolymer(s),
from 5% to 80% by weight of acrylic and/or methacrylic monomers, preferably between 30% and 70% by weight,
from 5% to 80% by weight of acrylic and/or methacrylic oligomers, preferably between 10% and 30% by weight,
from 1% to 10% by weight, preferably between 5% and 7% by weight of adhesion promoters,
from 0.5% to 10% by weight, preferably between 0.5% and 4% by weight of one or more photoinitiators;
the composition further comprises from 0 to 10% by weight, preferably between 5% and 10% by weight of physical and/or chemical rheological additives;
the photoinitiator(s) is (are) chosen from at least one of the following compounds: benzophenone, phosphine oxide, a,a-dihydroxyketone and aminoketone, iodonium salt, and phenylglyoxylate.

Other advantages and features of the invention will become apparent on reading the following description given by way of illustrative and non-limiting example, with reference to the appended figures, of which;

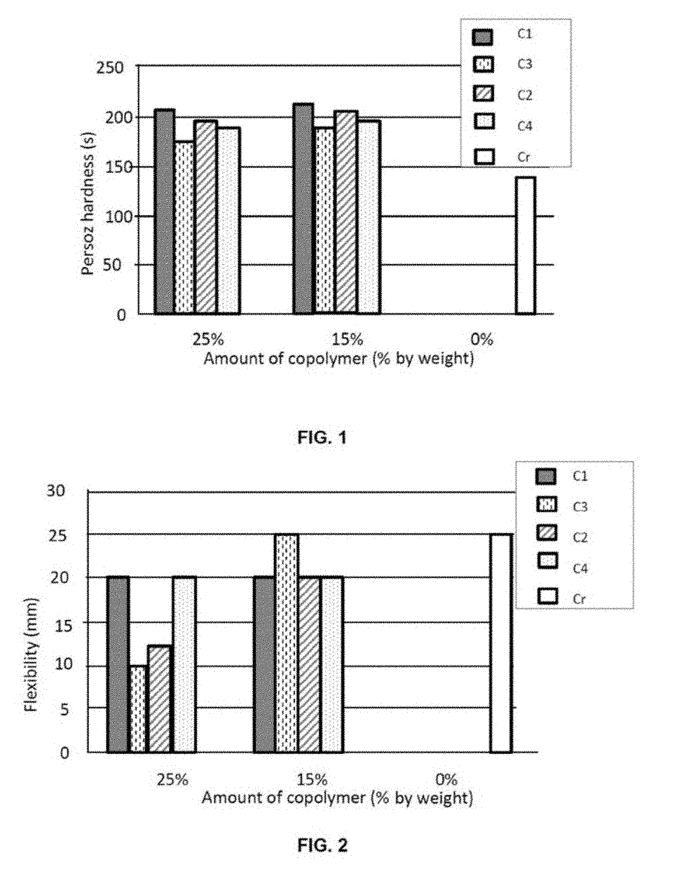

FIG. 1 depicts graphs representing the value of the Persoz hardness measured on several (meth)acrylic compositions crosslinked under UV radiation, as a function of the concentration of (meth)acrylic block copolymer dissolved in said compositions,

FIG. 2 depicts graphs representing the value of the flexibility measured on several (meth)acrylic compositions crosslinked under UV radiation, as a function of the concentration of (meth)acrylic block copolymer dissolved in said compositions.

### DESCRIPTION OF THE INVENTION

In the remainder of the description, the expression “photopolymerizable composition” or “photocrosslinkable composition” is understood to mean a composition for which the initiation of the polymerization is triggered by exposure to electromagnetic radiation. Preferably, the initiation of the polymerization of the composition according to the invention is triggered by exposure to ultraviolet (UV) radiation.

A “polymer” is understood to mean either a copolymer or a homopolymer.

The term “monomer” as used relates to a molecule which can undergo a polymerization.

The term “polymerization” as used relates to the process of conversion of a monomer or of a mixture of monomers into a polymer.

The term “copolymer” is understood to mean a polymer bringing together several different monomer units.

The term “homopolymer” is understood to mean a polymer bringing together identical monomer units.

The term “block copolymer” is understood to mean a polymer comprising one or more uninterrupted sequences of each of the separate polymer entities, the polymer sequences being chemically different from one another and being bonded to one another via a covalent bond.

The term “(meth)acrylic” as used relates to any type of acrylic and methacrylic compounds, polymers, monomers or oligomers. However, it would not be outside the scope of the invention if the (meth)acrylic matrix and/or the (meth)acrylic block copolymer were to comprise up to 10% by weight, preferably less than 5% by weight of other non-acrylic monomers, chosen from the group: butadiene, isoprene, styrene, substituted styrene such as α-methylstyrene or tert-butylstyrene, cyclosiloxanes, vinylnaphthalenes and vinylpyridines.

The term “thermoplastic polymer” as used relates to a polymer having a glass transition temperature Tg above ambient temperature.

The term “thermosetting polymer” as used relates to a plastic material which is converted irreversibly by polymerization into an insoluble polymer network.

Within the meaning of the invention, an “oligomer” is a polymer compound of small size, comprising between 2 and 30 monomers, i.e. the degree of polymerization of which is between 2 and 30.

The composition according to the invention is advantageously a one-component, i.e. “ready-to-use” composition which does not need to be separated into two to prevent it polymerizing by itself. The composition comprises one or more photoinitiators which make it possible to initiate the polymerization as soon as the composition is exposed to light radiation, and more particularly UV radiation. Consequently, all the constituents of the composition may be mixed without risk of an untimely polymerization, as long as the composition is not exposed to light radiation.

The photopolymerizable composition according to the invention advantageously comprises a (meth)acrylic block copolymer, or a blend of (meth)acrylic block copolymers, dissolved in a (meth)acrylic matrix, and one or more photoinitiators intended to enable the initiation of the crosslinking of the (meth)acrylic monomers and (meth)acrylic oligomer(s) of the (meth)acrylic matrix by exposure to light and in particular to UV rays.

### The (Meth)Acrylic Matrix

The (meth)acrylic monomers and oligomers are preferably chosen from alkyl acrylates and/or alkyl methacrylates. The constituent monomers of the matrix may be aliphatic, linear and/or branched acrylic and/or methacrylic monomers, and/or cyclic methacrylate monomers, and/or aromatic methacrylate monomers.

Preferably, said (meth)acrylic monomer is chosen from acrylic acid, methacrylic acid, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons. Advantageously, the (meth)acrylic monomers are chosen from the following groups:
esters of an alcohol (monofunctional ester) or polyol (multifunctional ester) with acrylic or methacrylic acid, the functionality possibly ranging from 1 to 6. Said alcohol or polyol may be alkoxylated (ethoxy or propoxy). Said alcohol or polyol may be linear or branched, aliphatic or cycloaliphatic;
monofunctional or multifunctional epoxy acrylates or methacrylates derived from the reaction of acrylic or methacrylic acid with a monoepoxidized or polyepoxidized compound;
urethane acrylates derived from the reaction of a hydroxylated acrylate or methacrylate (such as hydroxyalkyl acrylate or methacrylate with a C2 to C4 alkyl, in particular hydroxyethyl acrylate or methacrylate, HEA or HEMA) with a preferably aliphatic or cycloaliphatic isocyanate or polyisocyanate;
aminoacrylates with monofunctional or multifunctional acrylates, derived from the Michael addition of a secondary amine to a multifunctional acrylate and partial saturation, by this addition, of the acrylate functions (with at least one if not more residual acrylate functions per am inoacrylate molecule).

The (meth)acrylic oligomers are chosen from the following groups:
polyether acrylates or methacrylates resulting from the esterification by acrylic or methacrylic acid of a polyether polyol or monool, having an Mn that may range up to 2000 (oligoether based on a C2 to C4 alkoxy unit, in particular polyoxyethylenes or polyoxypropylenes or oxyethylene/oxypropylene random or block copolyethers). The polyoxyethylene or polyoxypropylene is also referred to as polyethylene glycol or polypropylene glycol;
polyester acrylates or methacrylates derived from the esterification by acrylic or methacrylic acid of a polyester polyol or monad. Said polyesters are polycondensation products of a polyacid (diacid) and a polyol (diol) and may be of variable structure depending on the structures of these polyacid and/or polyol components;
polyurethane acrylates or methacrylates that may result from the esterification reaction of a polyurethane polyol or monool by acrylic or methacrylic acid or from the reaction between a polyurethane polyisocyanate prepolymer (oligomer) and a hydroxyalkyl acrylate or methacrylate;
epoxy acrylate oligomers resulting from the acrylation or methacrylation of a monoepoxidized or polyepoxidized oligomer (for example epoxidized oligodienes such as epoxidized polybutadiene or epoxidized polyunsaturated oils);
acrylate or methacrylate acrylic oligomers such as copolymers of glycidyl methacrylate (GLYMA) with another acrylic or methacrylic comonomer, by reaction with acrylic or methacrylic acid.

Preferably, the adhesive composition comprises from 5% to 80% by weight, and more preferably from 30% to 70% by weight of (meth)acrylic monomers.

Preferably, the adhesive composition comprises from 5% to 80% by weight, and more preferably from 10% to 30% by weight of (meth)acrylic oligomers.

Preferably, the matrix is entirely (meth)acrylic, so that the monomers and the oligomers that it comprises are all (meth)acrylic oligomers and monomers.

### The (Meth)Acrylic Block Copolymer

Reference will subsequently be made to a “(meth)acrylic copolymer” to denote a (meth)acrylic copolymer or a blend of (meth)acrylic copolymers.

The block copolymer is said to be “(meth)acrylic” in that at least one of its constituent blocks is a polymer or copolymer based on (meth)acrylic monomers.

The (meth)acrylic block copolymer is preferably chosen from block copolymers comprising one or more M blocks and one or more B blocks.

More particularly, block copolymers having one of the following structures will be chosen: B-M, M-B-M, wherein each block is connected to the other by means of a covalent bond or an intermediate molecule connected to one of the blocks by a covalent bond and to the other block by another covalent bond, and wherein M is a polymer block of polymethyl methacrylate (PMMA) homopolymer or a copolymer comprising at least 50% by weight of methyl methacrylate, and wherein B is an elastomeric polymer block incompatible with the (meth)acrylic matrix and with the M block, and the glass transition temperature (Tg) of which is below ambient temperature, advantageously below 0° C. and preferably below −20° C.

Regarding the B-M diblock, the M block is constituted of methyl methacrylate monomers or contains at least 50% by weight of methyl methacrylate, preferably at least 75% by weight of methyl methacrylate. The other monomers constituting the M block may be acrylic or non-acrylic monomers.

Among the non-acrylic monomers that may constitute the M block, mention may be made, by way of nonlimiting example, of the monomers chosen from the group: butadiene, isoprene, styrene, substituted styrene such as a-methylstyrene or tert-butylstyrene, cyclosiloxanes, vinyl naphthalenes and vinylpyridines.

Advantageously, the monomers that may constitute the M block are chosen from methyl methacrylate, ethyl methacrylate, methyl acrylate, ethyl acrylate, methacrylic acid, acrylic acid, propyl methacrylate, propyl acrylate, n-butyl acrylate, isobutyl acrylate, n-butyl methacrylate, isobutyl methacrylate, pentyl methacrylate, pentyl acrylate, hexyl methacrylate, hexyl acrylate, cyclohexyl acrylate, cyclohexyl methacrylate, isobornyl acrylate, isobornyl methacrylate, amides derived from acrylic acid or from methacrylic acid such as N,N-dimethylacrylamide (DMA), 2-methoxyethyl acrylate or methacrylate, 2-aminoethyl acrylate or methacrylate, polyethylene glycol (PEG) (meth)acrylate, wherein the PEG group has a molar mass ranging from 400 to 10 000 g/mol, and mixtures thereof.

The monomer used to synthesize the elastomeric B block may be an alkyl (meth)acrylate; the following Tg values, between parentheses after the name of the acrylate, are obtained: ethyl acrylate (−24° C.), butyl acrylate (−54° C.), 2-ethylhexyl acrylate (−85° C.), hydroxyethyl acrylate (−15° C.) and 2-ethylhexyl methacrylate (−10° C.). Use is advantageously made of butyl acrylate. According to one embodiment, the B block further comprises up to 5% by weight of acrylic or non-acrylic monomers, such as acrylic acid, methacrylic acid, styrene, butadiene, a substituted styrene, isoprene, a cyclosiloxane, a vinylnaphthalene or a vinylpyridine.

The B-M diblock has a number-average molar mass that may be between 10 000 g/mol and 500 000 g/mol, preferably between 20 000 and 200 000 g/mol. The B-M diblock is advantageously constituted of a weight fraction of M of between 5% and 95% and preferably of between 15% and 85%.

Regarding the M-B-M triblock, M is constituted of the same monomers and optionally comonomers as the M block of the B-M diblock. The two M blocks of the M-B-M triblock may be identical or different. They may also be different due to their molar mass but be constituted of the same monomers. The B block is constituted of the same monomers and optionally comonomers as the B block of the B-M diblock.

The M-B-M triblock has a number-average molar mass that may be between 10 000 g/mol and 500 000 g/mol, preferably between 20 000 and 200 000 g/mol. Advantageously, the M-B-M triblock has the following compositions of M and B expressed as a weight fraction, the total being 100%:
M: between 10% and 80% and preferably between 15% and 70%.
B: between 90% and 20% and preferably between 85% and 30%.

The block copolymers used in the materials of the present invention may be manufactured by controlled radical polymerization (CRP) for example according to the processes described in documents WO 96/24620 and WO 00/71501.

According to one embodiment, at least one among the M and B blocks is functionalized by means of one or more functions chosen from acid, amine, amide, epoxy and thiol functions, quaternary ammonium groups, chlorinated groups and fluorinated groups.

Preferably, the (meth)acrylic block copolymer comprises only (meth)acrylic blocks, that is to say that all its blocks are polymers or copolymers based (meth)acrylic monomers. In particular, the B and M blocks of the B-M diblock or M-B-M triblock copolymer are polymers based on (meth)acrylic monomers.

According to one embodiment, the block copolymer comprises no styrene functional groups or monomers.

Preferably, the photopolymerizable adhesive composition according to the invention comprises between 0.1% and 40% by weight of (meth)acrylic block copolymer dissolved in the (meth)acrylic matrix, More preferably still, it comprises between 1% and 20%, and advantageously between 5% and 15% by weight of block copolymer.

As regards the photoirtitiator(s), these are advantageously chosen from at least one of the following compounds: benzophenone, phosphine oxide, α,α-dihydroxyketone, aminoketone, iodonium salt, and phenylglyoxylate.

Preferably, the photopolymerizable composition according to the invention comprises between 0.5% and 10% by weight of photoinitiator, and more preferably it contains between 0.5% and 4% by weight thereof.

Depending on the application for which the photopolymerizable composition is intended, this composition may further comprise various additives. Preferably, it comprises between 0% and 20% by weight of additives such as for example physical and/or chemical rheological additives, and adhesion promoters.

### EXAMPLES

The Persoz hardness and the flexibility of various (meth)acrylic compositions obtained after photocrosslinking were measured and compared in order to evaluate the effect of introducing one or more (meth)acrylic block copolymers into such a composition.

The test for measuring the Persoz hardness, carried out according to the standard ISO 1522, consists in measuring the damping time of a pendulum oscillating on a test surface. The oscillation amplitude of the pendulum, which depends on the hardness, is detected by means of photoelectric beams of the pendulum. It decreases more quickly on soft surfaces. The composition to be examined is applied as a 100 μm thick film on a test surface consisting of a glass plate. The composition is crosslinked by passing under a Fusion Hg 120 W/cm² UV lamp at a speed of 10 m/min. The result of the Persoz hardness test is given as number of oscillations before the damping of the oscillations of the pendulum in contact with the glass plate coated with the crosslinked composition, that is to say when the amplitude of the oscillations goes from 12° to 4°.

As for the flexibility measurement, it consists in applying a 100 μm thick film of the composition to be examined to a Q-Panel Brand test plate, made of 2.5 mm thick smooth steel, the commercial reference of which is Q-Panel D-46®. The composition is crosslinked by passing the steel plate coated with the film of said composition under a Fusion Hg 120 W/cm² UV lamp at a speed of 10 m/min. The plate coated with the photocrosslinked composition is then bent around cylindrical mandrels, according to the standard ISO 1519. The result of the measurement is expressed by the value (in mm) of the smallest radius of curvature that can be inflicted on the coating without it cracking, or detaching from the support.

The various compositions studied are the following:

A first reference composition, referenced Cr in FIGS. 1 and 2, comprises a (meth)acrylic matrix based on 3-methyl-1,5-pentanediol diacrylate (MPDA) monomers, and a photoinitiator, The short polymer chains obtained by polymerization of this monomer give a high degree of crosslinking and consequently a hard and brittle film.

A second composition, referenced C1, comprises the matrix of the reference composition Cr, in which a poly(methyl methacrylate-butyl acrylate-methyl methacrylate) (PMMA-b-PBA-b-PMMA) block copolymer is dissolved, the commercial name of which is “Nanostrength”. The composition further comprises the same photoinitiator as the reference composition Cr.

A third composition, referenced C2, comprises the same matrix and the same photoinitiator as the reference composition Cr. A poly(methyl methacrylate-butyl acrylate-methyl methacrylate) (PMMA-b-PBA-b-PMMA) block copolymer, the commercial name of which is “Nanostrength”, is dissolved in the matrix. The difference between the second and third compositions C1 and C2 lies essentially in the polarity of the block copolymer dissolved in the matrix. The molar mass of the two block copolymers of these two compositions being substantially identical.

A fourth composition, referenced C3, comprises the same matrix and the same photoinitiator as the reference composition Cr. A poly(methyl methacrylate-butyl acrylate-methyl methacrylate) (PMMA-b-PBA-b-PMMA) block copolymer, the commercial name of which is “Nanostrength”, is dissolved in the matrix. The molar mass of this block copolymer is very high relative to the molar mass of the block copolymers incorporated into the second and third compositions C1 and C2. The ratio between the blocks is moreover different and the block copolymer is functionalized with a functional group different from the other block copolymers of the other compositions.

A fifth composition, referenced C4, comprises the same matrix and the same photoinitiator as the reference composition Cr. A poly(methyl methacrylate-butyl acrylate) (PMMA-b-PBA) block copolymer, the commercial name of which is “Nanostrength”, is dissolved in the matrix. The ratio between the blocks of this block copolymer are similar to that of the block copolymers incorporated into the second and third compositions C1 and C2, but its molar mass is much lower.

The block copolymers are dissolved in each (meth)acrylic matrix at a temperature of 90° C. in order to reduce the dissolution time. However, it remains possible to carry out this dissolution step at ambient temperature.

The solutions obtained are stable, homogeneous, transparent and have a viscosity that varies as a function of the amount of block copolymer dissolved.

Added to these solutions is a photoinitiator in a proportion of 4% by weight. This photoinitiator is a hydroxyketone, the commercial name of which is “Speecure®1173”.

Each composition is subjected to UV radiation under a Fusion 120 W/cm² lamp conveyed on a conveyor at a speed of 10 m/min for polymerization.

The Persoz hardness and the flexibility of the various compositions were then measured according to the protocols described above.

FIGS. 1 and 2 respectively represent the hardness and the flexibility of the various compositions Cr to C4 after crosslinking, as a function of two different concentrations of block copolymers, the respective concentrations being 15% and 25% by weight.

It emerges from FIGS. 1 and 2 that the addition of (meth)acrylic block copolymer in the (meth)acrylic composition has a positive effect on the hardness/flexibility compromise compared to the reference composition Cr. Composition C2, especially, makes it possible to obtain the best compromise of performance compared to the other block copolymer grades.

1. A photopolymerizable composition comprising a (meth)acrylic matrix, further comprising a (meth)acrylic block copolymer, or a blend of (meth)acrylic block copolymers, dissolved in said (meth)acrylic matrix and one or more photoinitiators, wherein the photopolymerizable composition comprises from 5% to 15% by weight of said (meth)acrylic block copolymer or blend of (meth)acrylic block copolymers.

2. The photopolymerizable composition as claimed in claim 1, wherein the (meth)acrylic matrix comprises one or more acrylic monomers, methacrylic monomers, acrylic oligomers or methacrylic oligomers.

3. The photopolymerizable composition as claimed in claim 1, wherein said (meth)acrylic block copolymer is selected from block copolymers having one of the following structures: B-M- , or M-B-M, wherein:
each block is connected to the other by means of a covalent bond or an intermediate molecule connected to one of the blocks by a covalent bond and to the other block by another covalent bond,
M is a polymer block of polymethyl methacrylate (PMMA) homopolymer or a copolymer comprising at least 50% by weight of methyl methacrylate,
B is an elastomeric polymer block incompatible with the (meth)acrylic matrix and with the M block, and the glass transition temperature (Tg) of which is below ambient temperature.

4. The photopolymerizable composition as claimed in claim 1, wherein all the blocks of said (meth)acrylic block copolymer are polymers or copolymers based on (meth)acrylic monomers.

5. The photopolymerizable composition as claimed in claim 1, wherein the oligomers and monomers constituting the (meth)acrylic matrix are all (meth)acrylic oligomers and monomers.

6. The photopolymerizable composition as claimed in claim 1, wherein the (meth)acrylic matrix and/or the (meth)acrylic block copolymer comprises up to 10% by weight of other non-acrylic monomers, selected from the group consisting of: butadiene, isoprene, styrene, substituted styrene, cyclosiloxanes, vinylnaphthalenes and vinylpyridines and combinations thereof.

7. The photopolymerizable composition as claimed in claim 3, wherein the monomers constituting the M block are selected from the group consisting of methyl methacrylate, ethyl methacrylate, methyl acrylate, ethyl acrylate, methacrylic acid, acrylic acid, propyl methacrylate, propyl acrylate, n-butyl acrylate, isobutyl acrylate, n-butyl methacrylate, isobutyl methacrylate, pentyl methacrylate, pentyl acrylate, hexyl methacrylate, hexyl acrylate, cyclohexyl acrylate, cyclohexyl methacrylate, isobornyl acrylate, isobornyl methacrylate, amides derived from acrylic acid or from methacrylic acid, 2 methoxyethyl acrylate, 2-methoxyethyl methacrylate, 2-aminoethyl acrylate, 2-aminoethyl methacrylate, polyethylene glycol (PEG) (meth)acrylate, comprising a PEG group having a molar mass ranging from 400 to 10 000 g/mol, and mixtures thereof.

8. The photopolymerizable composition as claimed in claim 3, wherein the B block is a polymer of an alkyl (meth)acrylate selected from the group consisting of ethyl acrylate, butyl acrylate, 2-ethylhexyl acrylate, hydroxyethyl acrylate and 2-ethylhexyl methacrylate.

9. The photopolymerizable composition as claimed in claim 8, wherein the B block further comprises up to 5% by weight of one or more acrylic or non-acrylic monomers.

10. The photopolymerizable composition as claimed in claim 3, wherein at least one among the M and B blocks is functionalized by means of one or more functional groups selected from the group consisting of acid groups, amine groups, amide groups, epoxy groups, thiol groups, quaternary ammonium groups, chlorinated groups and fluorinated groups.

11. The photopolymerizable composition as claimed in claim 2, wherein said acrylic monomer or methacrylic monomer is selected from the group consisting of acrylic acid, methacrylic acid, alkyl acrylic monomers, alkyl methacrylic monomers and mixtures thereof.

12. The photopolymerizable composition as claimed in claim 2, wherein the photopolymerizable composition is comprised of one or more (meth)acrylic oligomers selected from the group consisting of:
polyether acrylates and polyether methacrylates resulting from the esterification by acrylic or methacrylic acid of a polyether polyol or polyether monool, having an Mn up to 2000;
polyester acrylates and polyester methacrylates derived from the esterification by acrylic acid or methacrylic acid of a polyester polyol or monool;
polyurethane acrylates and polyurethane methacrylates that may result from the esterification reaction of a polyurethane polyol or polyurethane monool by acrylic or methacrylic acid or from the reaction between a polyurethane polyisocyanate prepolymer (oligomer) and a hydroxyalkyl acrylate or hydroxyalkyl methacrylate;
epoxy acrylate oligomers and epoxy methacrylate oligomers resulting from the acrylation or methacrylation of a monoepoxidized oigomer or polyepoxidized oligomer; and
acrylate acrylic oligomers and methacrylate acrylic oligomers.

13. The photopolymerizable composition as claimed in claim 1, wherein the photopolymerizable composition comprises:
from 5% to 15% by weight of one or more (meth)acrylic block copolymer(s),
from 5% to 80% by weight of one or more acrylic monomers and/or methacrylic monomers,
from 5% to 80% by weight of one or more acrylic oligomers and/or methacrylic oligomers,
from 1% to 10% by weight of one or more adhesion promoters,
from 0.5% to 10% by weight of one or more photoinitiators.

14. The photopolymerizable composition as claimed in claim 1, wherein the (meth)acrylic matrix is a thermosetting matrix, and the photopolymerizable composition is photocrosslinkable.

15. The photopolymerizable composition as claimed in claim 1, wherein the photoinitiator(s) is (are) selected from the group consisting of: benzophenones, phosphine oxides, α,α-dihydroxyketones, aminoketones, iodonium salts, and phenylglyoxylate and combinations thereof.

16. The photopolymerizable composition as claimed in claim 2, wherein said acrylic monomer or methacrylic monomer is selected from the group consisting of: esters of an alcohol or polyol with acrylic acid or methacrylic acid; esters of an alkoxylated alcohol or alkoxylated polyol with acrylic acid or methacrylic acid; monofunctional and multifunctional epoxy acrylates and epoxy methacrylates derived from the reaction of acrylic or methacrylic acid with a monoepoxidized or polyepoxidized compound; urethane acrylates and urethane methacrylates derived from the reaction of a hydroxylated acrylate or hydroxylated methacrylate with an isocyanate or polyisocyanate; and aminoacrylates with monofunctional or multifunctional acrylates, derived from the Michael addition of a secondary amine to a multifunctional acrylate and partial saturation, by this addition, of the acrylate functions, with at least one residual acrylate function per aminoacrylate molecule.

17. The photopolymerizable composition as claimed in claim 1, wherein the photopolymerizable composition comprises:
from 5% to 15% by weight of one or more (meth)acrylic block copolymer(s),
from 30% to 70% by weight of one or more acrylic monomers and/or methacrylic monomers,
from 10% to 30% by weight of one or more acrylic oligomers and/or methacrylic oligomers,
from 1% to 10% by weight of one or more adhesion promoters,
from 0.5% to 4% by weight of one or more photoinitiators.
